(19) United States
(12) Patent Application Publication
(10) Pub. No.: US 2017/0213509 A1
(43) Pub. Date: Jul. 27, 2017

(54) DISPLAY APPARATUS

(71) Applicant: Samsung Display Co., Ltd., Yongin-si (KR)

(72) Inventors: Haksun Kim, Seoul (KR); Dongwon Park, Asan-si (KR); Jung-won Kim, Seoul (KR); Nam-Gon Choi, Yongin-si (KR); Seunghwan Moon, Asan-si (KR); Jaesung Bae, Suwon-si (KR)

(21) Appl. No.: 15/295,750

(22) Filed: Oct. 17, 2016

(30) Foreign Application Priority Data
Jan. 21, 2016 (KR) 10-2016-0007742

(51) Int. Cl. G09G 3/36; G09G 3/20

(52) U.S. Cl. CPC G09G 3/3614; G09G 3/3696; G09G 3/2003; G09G 2300/0823; G09G 2310/08; G09G 2300/0452

(57) ABSTRACT

Provided is a display apparatus. The display apparatus includes a plurality of gate lines, a plurality of data lines, and first to fourth pixels. The first to fourth pixels are disposed between two data lines adjacent to each other. The first and second pixels are disposed between an i-th gate line and an (i+1)-th gate line. The third and fourth pixels are disposed between a j-th gate line and a (j+1)-th gate line. The first to fourth pixels may have reference connection data lines different from each other or reference connection gate lines different from each other.

### CROSS-REFERENCE TO RELATED APPLICATION

This U.S. non-provisional patent application claims priority to and the benefit of Korean Patent Application No. 10-2016-0007742, filed on Jan. 21, 2016 in the Korean Intellectual Property Office, the entire content of which is hereby incorporated herein by reference.

### BACKGROUND

1. Field

The present disclosure herein relates to a display apparatus, and more particularly, to a liquid crystal display apparatus.

2. Description of the Related Art

In a liquid crystal display apparatus, electric fields are generated in a liquid crystal layer disposed between two substrates to change an arranged state of liquid crystal molecules, thereby adjusting transmittance of incident light to display an image.

A method for driving a liquid crystal display apparatus may be classified into a line inversion method, a column inversion method, and a dot inversion method according to the phase of the data voltage from one data line to the next. In the line inversion method, the phase of the data voltage applied to the data line is inverted for adjacent rows of pixels. In the column inversion method, the phase of the data voltage applied to the data line is inverted for adjacent columns of pixels. In the dot inversion method, the phase of the data voltage applied to the data line is inverted for adjacent rows and columns of pixels.

In general, display apparatuses may express a color by using three primary colors such as a red color, a blue color, and a green color. Thus, a display panel may include pixels respectively corresponding to the red, blue, and green colors.

Each of the pixels may be connected to a gate line and a data line to display an image according to signals applied to the gate line and the data line. A circuit in which a signal is applied to the gate line may be relatively easily realized and be relatively inexpensive when compared to a circuit in which a signal is applied to the data line.

### SUMMARY

Aspects of embodiments of the present disclosure are directed toward a display apparatus in which the number of data lines is reduced while resolution is maintained as it is, the number of driving circuit chips connected to data lines are reduced to reduce manufacturing costs, and a configuration thereof is simplified.

Aspects of embodiments of the present disclosure are directed toward a display apparatus of which display quality is not deteriorated even though pixels having various connection structures are provided.

An embodiment of the present disclosure provides display apparatuses including a plurality of gate lines, a plurality of data lines, and first color pixels.

The gate lines may extend in a first direction and be provided in an m number, where m is a natural number.

The data lines may extend in a second direction crossing the first direction and be provided in an n number, where n is a natural number.

The first color pixels may have the same color, and first to fourth pixels different from each other may be defined in the first color pixels.

The first to fourth pixels may be disposed between a k-th data line of the n data lines and a (k+1)-th data line of the n data lines, where k is a natural number that satisfies the following condition: 1≦k<n.

The first and second pixels may be disposed between an i-th gate line of the m gate lines and an (i+1)-th gate line of the m gate lines, where i is a natural number that satisfies the following condition: 1≦i<m.

The third and fourth pixels may be disposed between a j-th gate line of the m gate lines and a (j+1)-th gate line of the m gate lines, where j is a natural number that satisfies the following condition: 1≦j≠i<n.

The first and second pixels may be connected to one of the k-th data line and the (k+1)-th data line, and the third and fourth pixels may be connected to the other one of the k-th data line and the (k+1)-th data line.

The first pixel may be connected to one of the i-th gate line and the (i+1)-th gate line, and the second pixel may be connected to the other one of the i-th gate line and the (i+1)-th gate line.

The third pixel may be connected to one of the j-th gate line and the (j+1)-th gate line, and the fourth pixel may be connected to the other one of the j-th gate line and the (j+1)-th gate line.

The first pixel may be connected to the k-th data line and the (i+1)-th gate line. The second pixel may be connected to the k-th data line and the i-th gate line. The third pixel may be connected to the (k+1)-th data line and the j-th gate line. The fourth pixel may be connected to the (k+1)-th data line and the (j+1)-th gate line.

Data voltages applied to the first and second pixels may have the same polarity. Data voltages applied to the third and fourth pixels may have the same polarity. The data voltage applied to the first pixel and the data voltage applied to the third pixel may have polarities different from each other.

The first pixel may be disposed closer to the k-th data line when compared to the second pixel. The third pixel may be disposed closer to the k-th data line when compared to the fourth pixel.

The display apparatuses may further include second color pixels and third color pixels. The second color pixels may display a color different from that displayed by the first color pixels. The third color pixels may display a color different from those displayed by the first and second color pixels.

One of the first color pixels, one of the second color pixels, and one of the third color pixels may be sequentially disposed in the second direction.

Each of the first color pixels may display a red color, each of the second color pixels may display a green color, and each of the third color pixels may display a blue color.

The m gate lines may include two gate disposed between the one of the first color pixels and the one of the second color pixels, and the m gate lines may include two other gate lines disposed between the one of the second color pixels and the one of the third color pixels.

The first color pixels may include fifth to eighth pixels of the first color.

k may further satisfy the following condition: 1≦k<(n−1), and the fifth to eighth pixels may be disposed between the (k+1)-th data line and a (k+2)-th data line of the n data lines.

The fifth and sixth pixels may be disposed between the i-th gate line and the (i+1)-th gate line of the m gate lines.

The seventh and eighth pixels may be disposed between the j-th gate line and the (j+1)-th gate line of the m gate lines.

The fifth pixel may be connected to the (k+1)-th data line and the (i+1)-th gate line. The sixth pixel may be connected to the (k+1)-th data line and the i-th gate line. The seventh pixel may be connected to the (k+2)-th data line and the j-th gate line. The eighth pixel may be connected to the (k+2)-th data line and the (j+1)-th gate line.

Data voltages applied to the first pixel, the second pixel, the seventh pixel, and the eighth pixel may have the same polarity.

Data voltages applied to the third pixel, the fourth pixel, the fifth pixel, and the sixth pixel may have the same polarity.

The data voltage applied to the first pixel and the data voltage applied to the third pixel may have polarities different from each other.

The first color pixels may include fifth to eighth pixels of the first color. k may further satisfy the following condition: 1≦k<(n−1) The fifth to eighth pixels may be disposed between the (k+1)-th data line and a (k+2)-th data line of the n data lines. The fifth and sixth pixels may be disposed between the i-th gate line and the (i+1)-th gate line of the m gate lines. The seventh and eighth pixels may be disposed between the j-th gate line and the (j+1)-th gate line of the m gate lines.

The fifth pixel may be connected to the (k+1)-th data line and the i-th gate line. The sixth pixel may be connected to the (k+1)-th data line and the (i+1)-th gate line. The seventh pixel may be connected to the (k+2)-th data line and the (j+1)-th gate line. The eighth pixel may be connected to the (k+2)-th data line and the j-th gate line.

Each of the first to fourth pixels may have a long side extending in the first direction and a short side extending in the second direction.

In an embodiment of the present disclosure, a display apparatus includes a plurality of gate lines, a plurality of data lines, and first color pixels.

The gate lines may extend in a first direction and be provided in an m number, where m is a natural number.

The data lines may extend in a second direction crossing the first direction and be provided in an n number, where n is a natural number.

The first color pixels may have the same color, and first to fourth pixels different from each other may be defined in the first color pixels.

The first to fourth pixels may be disposed between a k-th data line of the n data lines and a (k+1)-th data line of the n data lines, where k is a natural number that satisfies the following condition: 1≦k<n.

The first and second pixels may be disposed between an i-th gate line of the m gate lines and an (i+1)-th gate line of the m gate lines, where i is a natural number that satisfies the following condition: 1≦i<m.

The third and fourth pixels may be disposed between a j-th gate line of the m gate lines and a (j+1)-th gate line of the m gate lines, where j is a natural number that satisfies the following condition: 1≦j≠i<n.

The first pixel may be disposed closer to the k-th data line when compared to the second pixel, and the third pixel may be disposed closer to the k-th data line when compared to the fourth pixel.

The first pixel may be connected to the (k+1)-th data line, the second pixel may be connected to the k-th data line, the third pixel may be connected to the k-th data line, and the fourth pixel may be connected to the (k+1)-th data line.

The first pixel may be connected to one of the i-th gate line and the (i+1)-th gate line, and the second pixel may be connected to the other one of the i-th gate line and the (i+1)-th gate line.

The third pixel may be connected to one of the j-th gate line and the (j+1)-th gate line, and the fourth pixel may be connected to the other one of the j-th gate line and the (j+1)-th gate line.

The first pixel may be connected to the (k+1)-th data line and the i-th gate line. The second pixel may be connected to the k-th data line and the (i+1)-th gate line. The third pixel may be connected to the k-th data line and the (j+1)-th gate line. The fourth pixel may be connected to the (k+1)-th data line and the j-th gate line.

Data voltages applied to the first and fourth pixels may have the same polarity. Data voltages applied to the second and third pixels may have the same polarity. The data voltage applied to the first pixel and the data voltage applied to the third pixel may have polarities different from each other.

The first color pixels may include fifth to eighth pixels of the first color. k may further satisfy the following condition: 1≦k<(n−1). The fifth to eighth pixels may be disposed between the (k+1)-th data line and a (k+2)-th data line of the n data lines. The fifth and sixth pixels may be disposed between the i-th gate line and the (i+1)-th gate line of the m gate lines. The seventh and eighth pixels may be disposed between the j-th gate line and the (j+1)-th gate line of the m gate lines.

The fifth pixel may be disposed closer to the (k+1)-th data line when compared to the sixth pixel, and the seventh pixel may be disposed closer to the (k+1)-th data line when compared to the eighth pixel.

The fifth pixel may be connected to the (k+2)-th data line and the i-th gate line. The sixth pixel may be connected to the (k+1)-th data line and the (i+1)-th gate line. The seventh pixel may be connected to the (k+1)-th data line and the (j+1)-th gate line. The eighth pixel may be connected to the (k+2)-th data line and the j-th gate line.

Data voltages applied to the first pixel, the fourth pixel, the sixth pixel, and the seventh pixel may have the same polarity. Data voltages applied to the second pixel, the third pixel, the fifth pixel, and the eighth pixel may have the same polarity. The data voltage applied to the first pixel and the data voltage applied to the second pixel may have polarities different from each other.

The first color pixels may include fifth to eighth pixels of the first color.

k may further satisfy the following condition: 1≦k<(n−1). The fifth to eighth pixels may be disposed between the (k+1)-th data line and a (k+2)-th data line of the n data lines. The fifth and sixth pixels may be disposed between the i-th gate line and the (i+1)-th gate line of the m gate lines. The seventh and eighth pixels may be disposed between the j-th gate line and the (j+1)-th gate line of the m gate lines.

The fifth pixel may be disposed closer to the (k+1)-th data line when compared to the sixth pixel, and the seventh pixel may be disposed closer to the (k+1)-th data line when compared to the eighth pixel.

The fifth pixel may be connected to the (k+1)-th data line and the (i+1)-th gate line. The sixth pixel may be connected to the (k+2)-th data line and the i-th gate line. The seventh pixel may be connected to the (k+2)-th data line and the j-th gate line. The eighth pixel may be connected to the (k+1)-th data line and the (j+1)-th gate line.

Data voltages applied to the first pixel, the fourth pixel, the fifth pixel, and the eighth pixel may have the same polarity.

Data voltages applied to the second pixel, the third pixel, the sixth pixel, and the seventh pixel may have the same polarity.

The data voltage applied to the first pixel and the data voltage applied to the second pixel may have polarities different from each other.

In an embodiment of the present disclosure, a display apparatus includes a plurality of gate lines, a plurality of data lines, and first color pixels.

The gate lines may extend in a first direction and be provided in an m number, where m is a natural number.

The data lines may extend in a second direction crossing the first direction and be provided in an n number, where n is a natural number.

The first color pixels may have the same color, and the first color pixels may include a first pixel, a second pixel, a third pixel, and a fourth pixel.

The first and second pixels may be disposed between a k-th data line of the n data lines and a (k+1)-th data line of the n data lines, where k is a natural number that satisfies the following condition: 1≦k<(n−1).

The third and the fourth pixels may be disposed between the (k+1)-th data line and a (k+2)-th data line of the n data lines.

The first to fourth pixels may be disposed between an i-th gate line of the m gate lines and an (i+1)-th gate line of the m gate lines, where i is a natural number that satisfies the following condition: 1≦i<m.

The first pixel may be disposed closer to the k-th data line when compared to the second pixel, and the third pixel may be disposed closer to the (k+1)-th data line when compared to the fourth pixel.

The first pixel may be connected to the (k+1)-th data line, the second pixel may be connected to the k-th data line, the third pixel may be connected to the (k+1)-th data line, and the fourth pixel may be connected to the (k+2)-th data line.

The first pixel may be connected to one of the i-th gate line and the (i+1)-th gate line, and the second pixel may be connected to the other one of the i-th gate line and the (i+1)-th gate line.

The third pixel may be connected to one of the i-th gate line and the (i+1)-th gate line, and the fourth pixel may be connected to the other one of the i-th gate line and the (i+1)-th gate line.

Each of the first and fourth pixels may be connected to the i-th gate line. Each of the second and third pixels may be connected to the (i+1)-th gate line.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain principles of the present disclosure. In the drawings:

FIG. 1 is a schematic block diagram of an embodiment of a liquid crystal display apparatus;

FIG. 2 is an equivalent circuit view of one pixel of FIG. 1;

FIG. 3 is a diagram depicting a partial layout of a liquid crystal panel according to an embodiment of the present disclosure; and

FIGS. 4 to 6 are diagrams of partial layouts of liquid crystal panels according to various embodiments of the present disclosure.

### DETAILED DESCRIPTION

Since the present disclosure may have diverse modified embodiments, specific embodiments are illustrated in the drawings and are described in the detailed description of the present disclosure. However, this does not limit the present disclosure within specific embodiments and it should be understood that the present disclosure covers all the modifications, equivalents, and replacements within the idea and technical scope of the present disclosure.

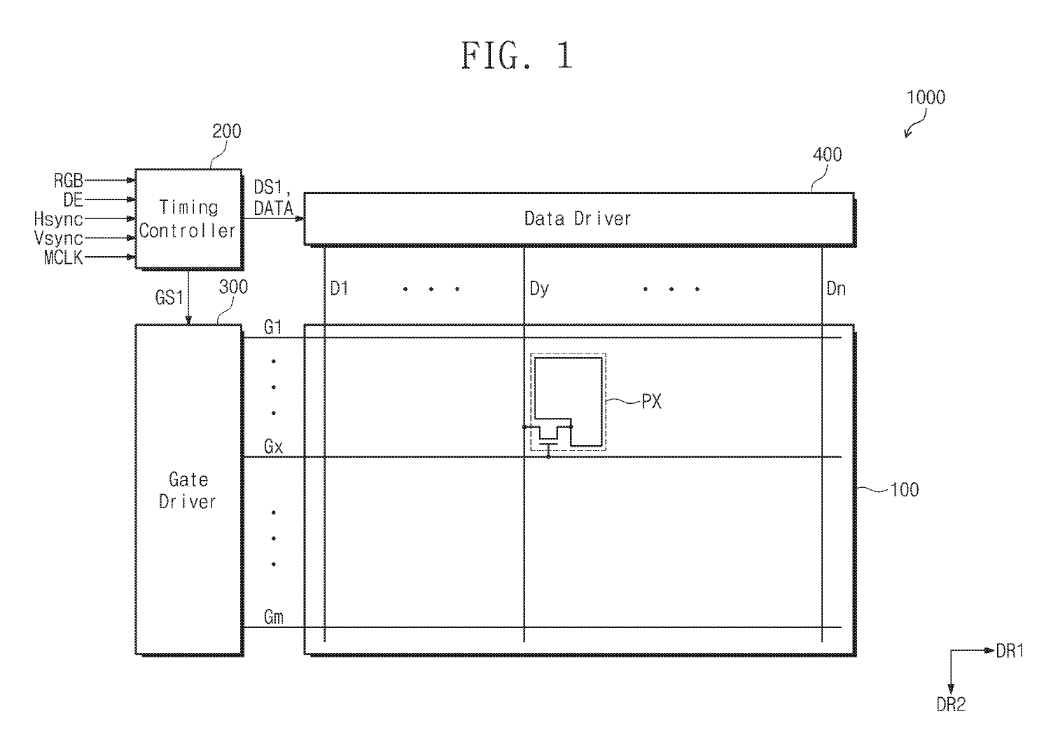

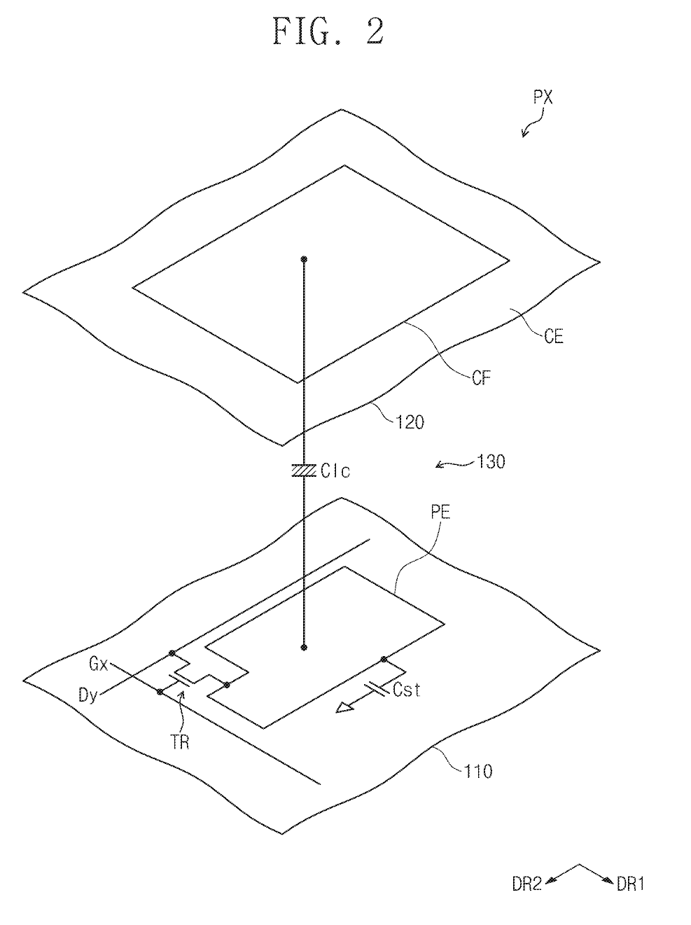

FIG. 1 is a schematic block diagram of an embodiment of a liquid crystal display apparatus, and FIG. 2 is an equivalent circuit view of one pixel of FIG. 1.

A liquid crystal display apparatus 1000 according to an embodiment of the present disclosure includes a liquid crystal panel 100, a timing controller 200, a gate driver 300, and a data driver 400.

The liquid crystal panel 100 may include a lower substrate 110, an upper substrate 120 facing the lower substrate 110, and a liquid crystal layer 130 disposed between the two substrates 110 and 120.

The liquid crystal panel 100 includes gate lines G1 to Gm, data lines D1 to Dn, and pixels (e.g. pixel PX). The gate lines G1 to Gm extend in a first direction DR1, and the data lines D1 and Dn extend in a second direction DR2 crossing the first direction DR1. Each of the pixels may be connected to one of the gate lines G1 to Gm and one of the data lines D1 to Dn to display an image. FIG. 1 illustrates an exemplary pixel PX connected to an x-th gate line Gx and a y-th data line Dy. In some embodiments, where gate lines or data lines are referred to by number (e.g. G1, G2, G3), in the spec and the claims, they are numbered consecutively (e.g. G1 is adjacent to G2, G2 is adjacent to G1 and G3).

The pixel PX may include a thin film transistor TR, a liquid crystal capacitor Clc, and a storage capacitor Cst. The thin film transistor TR may be connected to one of the gate lines G1 to Gm (e.g. the x-th gate line Gx) and one of the data lines D1 to Dn (e.g. the y-th gate line Dy). The liquid crystal capacitor Clc may be connected to the thin film transistor TR. The storage capacitor Cst may be connected in parallel with the liquid crystal capacitor Clc. The storage capacitor Cst may be omitted as occasion demands.

The thin film transistor TR may be disposed on the lower substrate 110. The thin film transistor TR may be a three terminal device and thus have a control terminal, one terminal, and the other terminal. The control terminal of the thin film transistor TR may be connected to the x-th gate line Gx, the one terminal may be connected to the y-th data line Dy, and the other terminal may be connected to the liquid crystal capacitor Clc and the storage capacitor Cst.

The liquid crystal capacitor Clc may use a pixel electrode PE positioned on the lower substrate 110 and a common electrode CE disposed on the upper substrate 120 as two terminals. A liquid crystal layer 130 between the two electrodes PE and CE may serve as a dielectric. The pixel electrode PE may be connected to the thin film transistor TR, and the common electrode CE may be positioned on substantially the entire surface of the upper substrate 120 to receive a common voltage. Unlike FIG. 2, the common electrode CE may be disposed on the lower substrate 110. Here, at least one of the two electrodes PE and CE may have a slit.

The storage capacitor Cst may serve as an auxiliary unit of the liquid crystal capacitor Clc. The storage capacitor Cst may include the pixel electrode PE, a storage line, and an insulator disposed between the pixel electrode PE and the storage line. The storage line may be disposed on the lower substrate 110 to overlap a portion of the pixel electrode PE. A uniform storage voltage may be applied to the storage line.

The pixel PX may display one of the primary colors. The primary colors may include red, green, blue, and white colors. However, an embodiment of the present disclosure is not limited thereto. For example, the primary colors may include various colors such as a yellow, cyan, and magenta. In an embodiment of the present disclosure, pixels including a red pixel, a green pixel, a blue pixel, and a white pixel.

The pixel PX may further include a color filter CF that displays one of the primary colors. Although the color filter CF is disposed on the upper substrate 120 in FIG. 2, an embodiment of the present disclosure is not limited thereto. For example, the color filter CF may be disposed on the lower substrate 110.

The timing controller 200 receives image data (‘RGB’) and a control signal from an external graphic control unit. The control signal may include a vertical synchronization signal (hereinafter, referred to as a Vsync signal′) that is a column discrimination signal, a horizontal synchronization signal (hereinafter, referred to as a ‘Hsync signal’) that is a row discrimination signal, a data enable signal (hereinafter, referred to as a ‘DE signal’) e.g. having a high level HIGH during only a period for which data is outputted to display a data input section, and a main clock signal (hereinafter, referred to as a ‘MCLK’ signal).

The timing controller 200 may convert image data RGB to match a specification of the data driver 400 and then output the converted image data DATA to the data driver 400. The timing controller 200 generates a gate control signal GS1 and a data control signal DS1. The timing controller 200 outputs the gate control signal GS1 to the gate driver 300 and outputs the data control signal DS1 to the data driver 400.

The gate control signal GS1 may be a signal for driving the gate driver 300, and the data control signal DS1 may be a signal for driving the data driver 400.

The gate driver 300 may generate a gate signal based on the gate control signal GS1 to output the generated gate signal to one of the gate lines G1 to Gm. The gate control signal GS1 may include at least one clock signal (which controls a scan start signal for instructing scan start and an output period of a gate on voltage) and an output enable signal (which limits a continuous time of the gate on voltage).

The data driver 400 may generate a grayscale voltage according to the converted image data DATA based on the data control signal DS1 to output the generated grayscale voltage to the data lines D1 to Dn as a data voltage. The data voltage may include a positive data voltage having a positive value and a negative data voltage having a negative value with respect to a reference voltage. The data control signal DS1 may include a horizontal start signal STH for communicating the start of the converted image data DATA to the data driver 400, a load signal by which the data voltage is applied to the data lines D1 to Dn, and an inversion signal for inverting a polarity of the data voltage with respect to the common voltage.

The polarity of the data voltage applied to the pixel PX may be inverted before the next frame starts after one frame is ended so as to prevent the liquid crystal from being degraded. That is, the polarity of the data voltage may be inverted by one frame unit in response to an inversion signal applied to the data driver 400. The liquid crystal panel 100 may be driven in a manner in which data voltages having polarities different from each other are applied by a unit of at least one data line to improve image quality when an image for one frame is displayed.

The data driver 400 may alternatingly output a positive data voltage and a negative data voltage for one data line.

Each of the timing controller 200, the gate driver 300, and the data driver 400 may be directly mounted on the liquid crystal panel 100 in the form of at least one integrated circuit chip, be mounted on a flexible printed circuit board and then attached to the liquid crystal panel 100 in the form of a tape carrier package (TCP), or be mounted on a separate printed circuit board. On the other hand, at least one of the gate driver 300 and the data driver 400 may be integrated with the liquid crystal panel 100 together with the gate lines G1 to Gm, the data lines D1 to Dn, and the thin film transistor TR. Also, the timing controller 200, the gate driver 300, and the data driver 400 may be integrated in the form of a single chip.

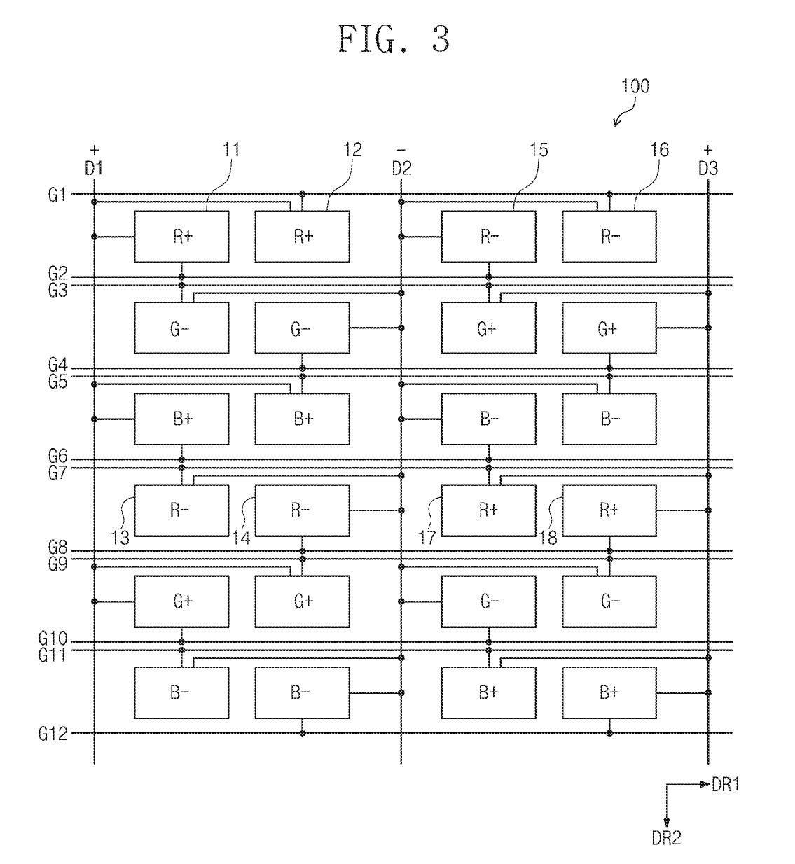

FIG. 3 is a diagram depicting a partial layout of the liquid crystal panel according to an embodiment of the present disclosure.

Although the thin film transistor provided in each of the pixels is not illustrated in FIG. 3, a control terminal of the thin film transistor of each pixel may be connected to the corresponding gate line, and one terminal of the thin film transistor of each pixel may be connected to the corresponding data line.

Referring to FIG. 3, the pixels may include first to third color pixels. Each of the first color pixels may be a red pixel for displaying a red color image, each of the second color pixels may be a green pixel for display a green color image, and each of the third color pixels may be a blue pixel for displaying a blue color image.

In an embodiment of the present disclosure, the pixels include red pixels, green pixels, blue pixels, and white pixels. However, an embodiment of the present disclosure is not limited thereto. For example, an arrangement order of the red pixel, the green pixel, and the blue pixel may vary.

In FIG. 3, the red pixel is expressed by a reference symbol R, the green pixel is expressed by a reference symbol G, and the blue pixel is expressed by a reference symbol B. Also, the pixels to which the positive (+) data voltage is applied may be expressed by reference symbols R+, G+, and B+, and the pixels to which the negative (−) data voltage is applied may be expressed by reference symbols R−, G−, and B−.

A polarity of the data voltage applied to each of the pixels of the liquid crystal panel 100 of FIG. 3 may denote a polarity of an i-th frame, and a polarity of the data voltage applied to each of the pixels may be inverted in an (i+1)-th frame. That is, the data driver 400 of FIG. 1 may invert the polarity of the data voltage, which is outputted to the data lines D1 to Dn, for each frame. The positive data voltage and the negative data voltage may be alternately applied to the data lines D1 to D3. Accordingly, the + and − notations indicate that the data voltage applied to those pixels is of different polarity for a given frame, but does not require that the data voltage be positive or negative for every frame.

Two pixels may be disposed within an area defined by two adjacent gate lines and two adjacent data lines. For example, two red pixels (R+) may be disposed within an area defined by the first and second gate lines G1 and G2 and the first and second data lines D1 and D2.

Two pixels adjacent to each other in a first direction DR1 may be disposed between two adjacent data lines. For example, two adjacent red pixels (R+) may be disposed between the first and second data lines D1 and D2.

One pixel may be disposed between two adjacent gate lines. Two adjacent gate lines may be disposed between two pixels adjacent to each other in a second direction DR2. For example, the second and third gate lines G2 and G3 may be disposed between a red pixel R and a green pixel G, which are adjacent to each other in the second direction DR2.

Each of the pixels may have an approximately or substantially rectangular shape. Each of the pixels may have a long side extending in the first direction DR1 and a short side extending in the second direction DR2.

In the display apparatus according to an embodiment of the present disclosure, the number of data lines may be reduced while the resolution of the display apparatus is maintained as it is. Thus, the number of driving circuit chips connected to the data lines may be reduced to reduce the manufacturing costs and simplify the configuration of the display apparatus.

Hereinafter, a connection relationship between the red pixels R and the data lines and a connection relationship between the red pixels R and the gate lines will be described. A corresponding connection relationship may apply to the other pixels.

Portions of the red pixels R may be defined as first to fourth red pixels 11 to 14.

The first to fourth red pixels 11 to 14 may be disposed between two adjacent data lines D1 and D2. A structure in which the first to fourth red pixels 11 to 14 are disposed between the first and second data lines D1 and D2 is exemplarily illustrated in FIG. 3.

The first and second red pixels 11 and 12 may be disposed between two adjacent gate lines. The third and fourth red pixels 13 and 14 may be disposed between another two adjacent gate lines. A structure in which the first and second red pixels 11 and 12 are disposed between the first and second gate lines G1 and G2 is exemplarily illustrated in FIG. 3. Also, a structure in which the third and fourth red pixels 13 and 14 are disposed between seventh and eighth gate lines G7 and G8 is exemplarily illustrated.

The first and third red pixels 11 and 13 may be disposed closer to the first data line D1 when compared to the second and fourth red pixels 12 and 14.

The first and second red pixels 11 and 12 may both be connected to one of the first and second data lines D1 and D2. The third and fourth red pixels 13 and 14 may both be connected to the other one of the first and second data lines D1 and D2. A structure in which the first and second red pixels 11 and 12 are connected to the first data line D1, and the third and fourth red pixels 13 and 14 are connected to the second data line D2 is exemplarily illustrated in FIG. 3.

The first red pixel 11 may be connected to one of the first and second gate lines G1 and G2, and the second red pixel 12 may be connected to the other one of the first and second gate lines G1 and G2. A structure in which the first red pixel 11 is connected to the second gate line G2, and the second red pixel 12 is connected to the first gate line G1 is exemplarily illustrated in FIG. 3.

The third red pixel 13 may be connected to one of the seventh and eighth gate lines G7 and G8, and the fourth red pixel 14 may be connected to the other one of the seventh and eighth gate lines G7 and G8. A structure in which the third red pixel 13 is connected to the seventh gate line G7, and the fourth red pixel 14 is connected to the eighth gate line G8 is exemplarily illustrated in FIG. 3.

In the liquid crystal panel 100 according to an embodiment of the present disclosure, each of the first to fourth red pixels 11 to 14 may have a different combination of reference connection data lines and reference connection gate lines.

A reference connection data line may be defined as a data line to which a pixel is connected, which can be a near-left data line, a distant-left data line, a near-right data line, and a distant-right data line. The first to fourth red pixels 11 to 14 may be connected to the near-left data line, the distant-left data line, the near-right data line, and the distant-right data line respectively.

For example, the first red pixel 11 may be connected to the near-left data line D1, and the second red pixel 12 may be connected to the distant-left data line D1. Also, the third red pixel 13 may be connected to the distant-right data line D2, and the fourth red pixel 14 may be connected to the near-right data line D2. That is, in an embodiment of the present disclosure, the first to fourth red pixels 11 to 14 may have reference connection data lines different from each other.

A reference connection gate line may be defined as a gate line to which a pixel is connected, which can be an upper gate line and a lower gate line of each pixel. Two red pixels of the first to fourth red pixels 11 to 14 may be connected to an upper gate line, and the other two red pixels may be connected to a lower gate line.

For example, the first red pixel 11 may be connected to the lower gate line G2, and the second red pixel 12 may be connected to the upper gate line G1. Also, the third red pixel 13 may be connected to the upper gate line G7, and the fourth red pixel 14 may be connected to the lower gate line G8.

In the first to fourth red pixels 11 to 14, the structure of the connection with the gate line (hereinafter “gate line connection structure”) and the structure of the connection with the data line (hereinafter “data line connection structure”) may vary because each pixel has a different combination of reference connection gate lines and reference connection data lines. These differing gate line connection structures and data line connection structures may cause the thin film transistors of the first to fourth red pixels 11 to 14 to have different shapes and different gate-source capacitances, which may result in the first to fourth red pixels 11 to 14 having different brightness for a given data voltage.

In the liquid crystal panel 100 according to an embodiment of the present disclosure, the reference connection data lines of the first to fourth red pixels 11 to 14 may be designed to be symmetric to each other, and the reference connection gate lines of the first to fourth red pixels 11 to 14 may be designed to be symmetric to each other. Accordingly, the average brightness of images displayed on the first to fourth red pixels 11 to 14 may be substantially the same from pixel to pixel for a given data voltage. Thus, in the display apparatus according to an embodiment of the present disclosure, even though pixels having various connection structures are provided, the display quality may not be deteriorated.

Portions of the red pixels R may be defined as fifth to eighth red pixels 15 to 18.

The fifth and sixth red pixels 15 and 16 may be disposed adjacent to each other in the first direction DR1. The fifth red pixel 15 may be disposed adjacent to the second red pixel 12 in the first direction DR1.

The seventh and eighth red pixels 17 and 18 may be disposed adjacent to each other in the first direction DR1. The seventh red pixel 17 may be disposed adjacent to the fourth red pixel 14 in the first direction DR1.

The fifth to eighth red pixels 15 to 18 may be disposed between the second and third data lines D2 and D3.

The fifth and sixth red pixels 15 and 16 may be disposed between the first and second gate lines G1 and G2. The seventh and eighth red pixels 17 and 18 may be disposed between the seventh and eighth gate lines G7 and G8.

The fifth and seventh red pixels 15 and 17 may be disposed closer to the second data D2 line when compared to the sixth and eighth red pixels 16 and 18.

The fifth and sixth red pixels 15 and 16 may be connected to one of the second and third data lines D2 and D3. The seventh and eighth red pixels 17 and 18 may be connected to the other one of the second and third data lines D2 and D3. A structure in which the fifth and sixth red pixels 15 and 16 are connected to the second data line D2, and the seventh and eighth red pixels 17 and 18 are connected to the third data line D3 is exemplarily illustrated in FIG. 3.

The fifth red pixel 15 may be connected to one of the first and second gate lines G1 and G2, and the sixth red pixel 16 may be connected to the other one of the first and second gate lines G1 and G2. A structure in which the fifth red pixel 15 is connected to the second gate line G2, and the sixth red pixel 16 is connected to the first gate line G1 is exemplarily illustrated in FIG. 3.

The seventh red pixel 17 may be connected to one of the seventh and eighth gate lines G7 and G8, and the eighth red pixel 18 may be connected to the other one of the seventh and eighth gate lines G7 and G8. A structure in which the seventh red pixel 17 is connected to the seventh gate line G7, and the eighth red pixel 18 is connected to the eighth gate line G8 is exemplarily illustrated in FIG. 3.

The data voltages applied to the first red pixel 11, the second red pixel 12, the seventh red pixel 17, and the eighth red pixel 18 may have the same polarity. An example in which the positive data voltage is applied to the first red pixel 11, the second red pixel 12, the seventh red pixel 17, and the eighth red pixel 18 is illustrated in FIG. 3.

The data voltages applied to the third red pixel 13, the fourth red pixel 14, the fifth red pixel 15, and the sixth red pixel 16 may have the same polarity. An example in which the negative data voltage is applied to the third red pixel 13, the fourth red pixel 14, the fifth red pixel 15, and the sixth red pixel 16 is illustrated in FIG. 3.

The voltage applied to the first red pixel 11 and the data voltage applied to the third red pixel 13 may have polarities different from each other.

In an embodiment of the present disclosure, in a set of pixels between two particular adjacent data lines, the pairs of pixels which are disposed in odd-numbered rows may have the same connection structure, and the pairs of pixels which are disposed in even-numbered rows may have the same connection structure.

The pixels disposed between the first and second data lines D1 and D2 will be exemplarily described. The first and second red pixels 11 and 12 disposed in a first row may have the same connection structure as blue pixels (B+) disposed in a third row and green pixels (G+) disposed in a fifth row.

The third and fourth red pixels 13 and 14 disposed in a fourth row may have the same connection structure as green pixels (G−) disposed in a second row and blue pixels (B−) disposed in a sixth row.

In an embodiment of the present disclosure, the pairs of pixels disposed in the same row including the pairs of pixels disposed between the first and second data lines D1 and D2 and the pairs of pixels disposed between the second and third data lines D2 and D3 may have the same connection structure. The first and second red pixels 11 and 12 and the fifth and sixth red pixels 15 and 16 may have the same connection structure. The third and fourth red pixels 13 and 14 and the seventh and eighth red pixels 17 and 18 may have the same connection structure.

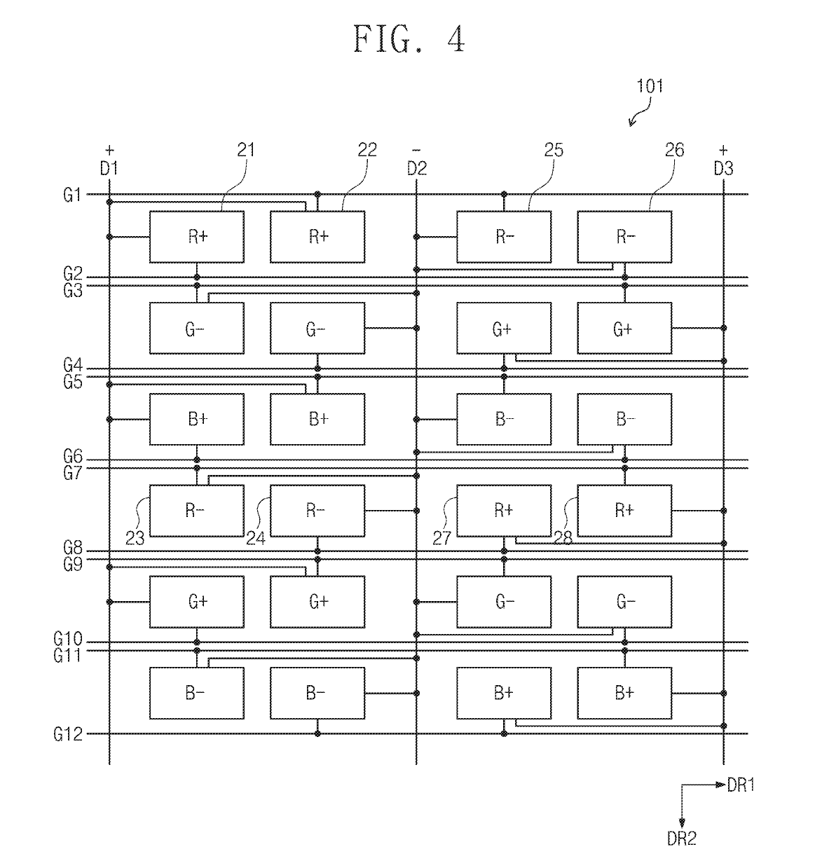

FIG. 4 is a diagram depicting a partial layout of a liquid crystal panel according to another embodiment of the present disclosure.

The differences between the liquid crystal display panel 101 of FIG. 4 and the liquid crystal display panel 100 of FIG. 3 will be described. Where it is not stated otherwise, the liquid crystal display panel 101 of FIG. 4 may function and be structured as disclosed relative to the liquid crystal display panel 100 of FIG. 3.

The liquid crystal panel 101 includes first to eighth red pixels 21 to 28.

The first to fourth red pixels 21 to 24 may be substantially the same as the first to fourth red pixels 11 to 14 of FIG. 3.

In an embodiment of the present disclosure, the pairs of pixels disposed between first and second data lines D1 and D2 may have different connection structures than the pairs of pixels disposed in the same row between the second and third data lines D2 and D3. For example, the first and second red pixels 21 and 22 and the fifth and sixth red pixels 25 and 26 may have connection structures different from each other.

The fifth red pixel 25 is connected to the second data line D2 and a first gate line G1. The sixth red pixel 26 is connected to the second data line D2 and a second gate line G2. The seventh red pixel 27 is connected to the third data line D3 and an eighth gate line G8. The eighth red pixel 28 is connected to the third data line D3 and a seventh gate line G7.

Each of the first to eighth red pixel 21 to 28 may have a different combination of reference connection data lines and reference connection gate lines.

The first red pixel 21 is connected to the near-left data line D1 and the lower gate line G2. The second red pixel 22 is connected to the distant-left data line D1 and the upper gate line G1. The third red pixel 23 is connected to the distant-right data line D2 and the upper gate line G7. The fourth red pixel 24 is connected to the near-right data line D2 and the lower gate line G8. The fifth red pixel 25 is connected to the near-left data line D2 and the upper gate line G1. The sixth red pixel 26 is connected to the distant-left data line D2 and the lower gate line G2. The seventh red pixel 27 is connected to the distant-right data line D3 and the lower gate line G8. The eighth red pixel 28 is connected to the near-right data line D3 and the upper gate line G7.

In the liquid crystal panel 101 according to an embodiment of the present disclosure, the reference connection data lines of the first to eighth red pixels 21 to 28 may be designed to be symmetric to each other, and the reference connection gate lines of the first to eighth red pixels 21 to 28 may be designed to be symmetric to each other. Accordingly, the average brightness of images displayed on the first to eighth red pixels 21 to 28 may be substantially the same from pixel to pixel for a given data voltage.

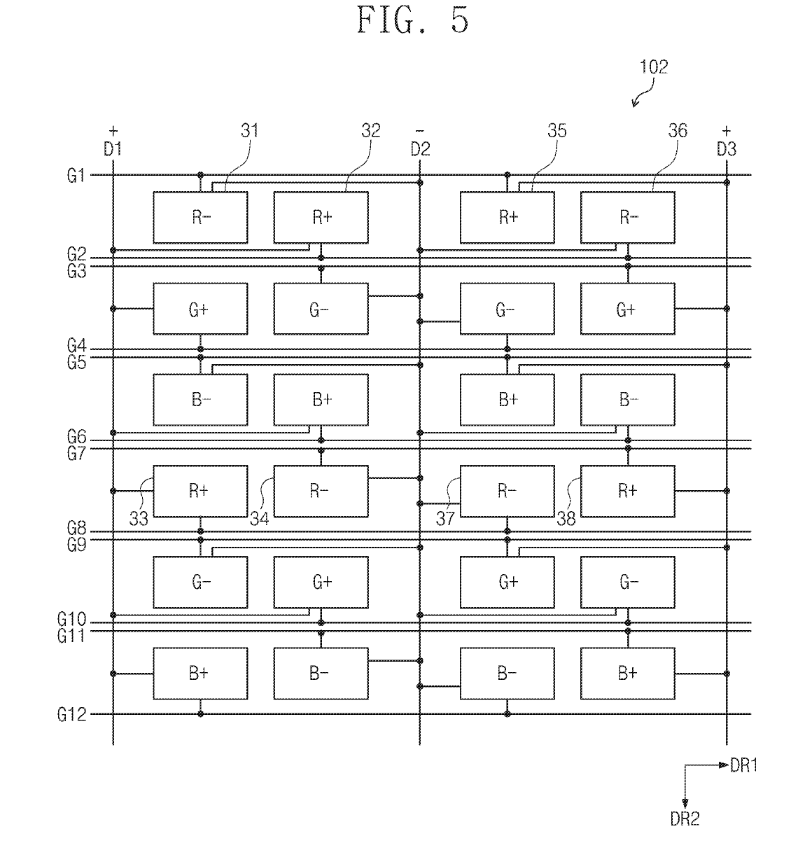

FIG. 5 is a diagram depicting a partial layout of a liquid crystal panel according to another embodiment of the present disclosure.

The differences between the liquid crystal display panel 102 of FIG. 5 and the liquid crystal display panel 100 of FIG. 3 will be described. Where it is not stated otherwise, the liquid crystal display panel 102 of FIG. 5 may function and be structured as disclosed relative to the liquid crystal display panel 100 of FIG. 3.

The liquid crystal panel 102 includes first to eighth red pixels 31 to 38.

The first red pixel 31 is connected to a second data line D2 and a first gate line G1. The second red pixel 32 is connected to a first data line D1 and a second gate line G2. The third red pixel 33 is connected to a first data line D1 and an eighth gate line G8. The fourth red pixel 34 is connected to the second data line D2 and a seventh gate line G7.

Each of the first to fourth red pixels 31 to 34 may have a different combination of reference connection data lines and reference connection gate lines.

The first red pixel 31 is connected to the distant-right data line D2 and the upper gate line G1. The second red pixel 32 is connected to the distant-left data line D1 and the lower gate line G2. The third red pixel 33 is connected to the near-left data line D1 and the lower gate line G8. The fourth red pixel 34 is connected to the near-right data line D2 and the upper gate line G7.

In the liquid crystal panel 102 according to an embodiment of the present disclosure, the reference connection data lines of the first to fourth red pixels 31 to 34 may be designed to be symmetric to each other, and the reference connection gate lines of the first to fourth red pixels 31 to 34 may be designed to be symmetric to each other. Accordingly, the average brightness of images displayed on the first to fourth red pixels 31 to 34 may be substantially the same from pixel to pixel for a given data voltage.

In an embodiment of the present disclosure, the pairs of pixels disposed in the same row including the pairs of pixels disposed between the first and second data lines D1 and D2 and the pairs of pixels disposed between the second and third data lines D2 and D3 may have the same connection structure. The first and second red pixels 31 and 32 and the fifth and sixth red pixels 35 and 36 may have the same connection structure. The third and fourth red pixels 33 and 34 and the seventh and eighth red pixels 37 and 38 may have the same connection structure.

The fifth red pixel 35 is connected to the third data line D3 and the first gate line G1. The sixth red pixel 36 is connected to the second data line D2 and a second gate line G2. The seventh red pixel 37 is connected to the second data line D2 and an eighth gate line G8. The eighth red pixel 38 is connected to the third data line D3 and a seventh gate line G7.

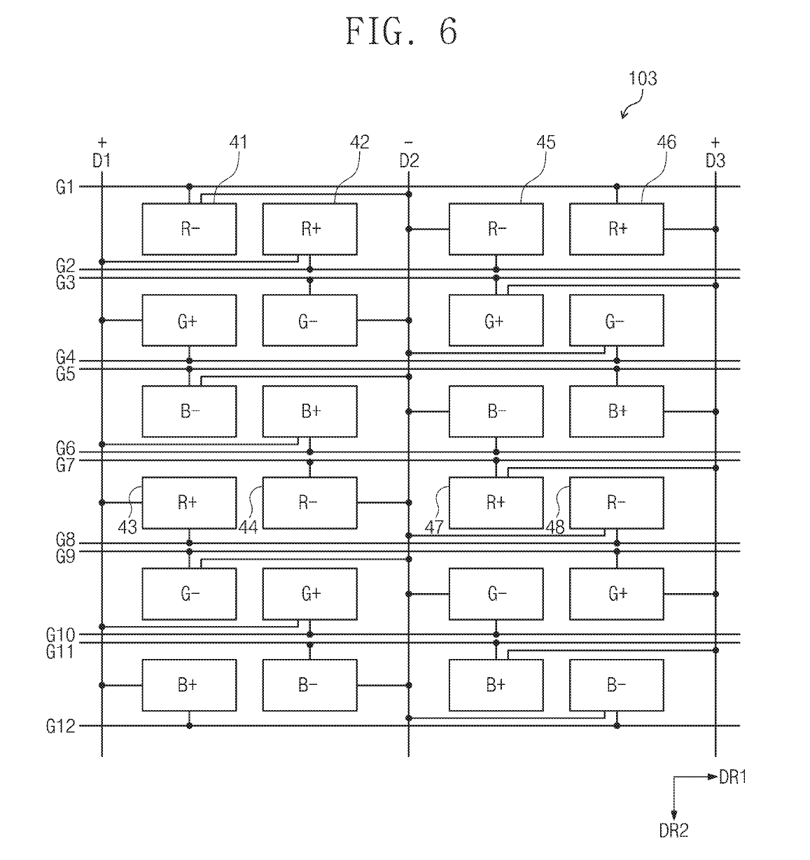

FIG. 6 is a diagram of a partial layout of a liquid crystal panel according to another embodiment of the present disclosure.

The differences between the liquid crystal display panel 103 of FIG. 6 and the liquid crystal display panel 102 of FIG. 5 will be described. Where it is not stated otherwise, the liquid crystal display panel 103 of FIG. 6 may function and be structured as disclosed relative to the liquid crystal display panel 102 of FIG. 5.

The liquid crystal panel 103 includes first to eighth red pixels 41 to 48.

The first to fourth red pixels 41 to 44 may be substantially the same as the first to fourth red pixels 31 to 34 of FIG. 5.

In an embodiment of the present disclosure, the pairs of pixels disposed between first and second data lines D1 and D2 may have different connection structures than the pairs of pixels disposed in the same row between the second and third data lines D2 and D3. For example, the first and second red pixels 41 and 42 and the fifth and sixth red pixels 45 and 46 may have connection structures different from each other.

The fifth red pixel 45 is connected to the second data line D2 and a second gate line G2. The sixth red pixel 46 is connected to the third data line D3 and a first gate line G1. The seventh red pixel 47 is connected to the third data line D3 and a seventh gate line G7. The eighth red pixel 48 is connected to the second data line D2 and an eighth gate line G8.

Each of the first to eighth red pixels 41 to 48 may have a different combination of reference connection data lines and reference connection gate lines.

In the liquid crystal panel 103 according to an embodiment of the present disclosure, the reference connection data lines of the first to eighth red pixels 41 to 48 may be designed to be symmetric to each other, and the reference connection gate lines of the first to eighth red pixels 41 to 48 may be designed to be symmetric to each other. Accordingly, the average brightness of images displayed on the first to eighth red pixels 41 to 48 may be substantially the same from pixel to pixel for a given data voltage.

The display apparatus according to an embodiment of the present disclosure may achieve a resolution with fewer data lines. Thus, the number of driving circuit chips connected to the data lines may be reduced to reduce the manufacturing costs and simplify the configuration of the display apparatus.

In the display apparatus according to an embodiment of the present disclosure, even though pixels having various connection structures are provided, the display quality may not be deteriorated.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

The use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

The modifications or changes made without departing from the spirit and scope of the present disclosure are evident to a person having ordinary skill in the art to which the present disclosure pertains. Hence, all such changes, modifications, or alterations, and equivalents thereof, should therefore be seen as within the scope of the disclosure.

What is claimed is:

1. A display apparatus comprising:
m gate lines extending in a first direction, where m is a natural number;
n data lines extending in a second direction crossing the first direction, where n is a natural number; and
first color pixels configured to display the same color, the first color pixels comprising a first pixel, a second pixel, a third pixel, and a fourth pixel,
wherein the first to fourth pixels are disposed between a k-th data line of the n data lines and a (k+1)-th data line of the n data lines, where k is a natural number that satisfies the following condition: 1≦k<n,
the first and second pixels are disposed between an i-th gate line of the m gate lines and an (i+1)-th gate line of the m gate lines, where i is a natural number that satisfies the following condition: 1≦i<m,
the third and fourth pixels are disposed between a j-th gate line of the m gate lines and a (j+1)-th gate line of the m gate lines, where j is a natural number that satisfies the following condition: 1≦j≠i<n,
the first and second pixels are connected to one of the k-th data line and the (k+1)-th data line, and the third and fourth pixels are connected to the other one of the k-th data line and the (k+1)-th data line,
the first pixel is connected to one of the i-th gate line and the (i+1)-th gate line, and the second pixel is connected to the other one of the i-th gate line and the (i+1)-th gate line, and
the third pixel is connected to one of the j-th gate line and the (j+1)-th gate line, and the fourth pixel is connected to the other one of the j-th gate line and the (j+1)-th gate line.

2. The display apparatus of claim 1, wherein the first pixel is connected to the k-th data line and the (i+1)-th gate line,
the second pixel is connected to the k-th data line and the i-th gate line,
the third pixel is connected to the (k+1)-th data line and the j-th gate line, and
the fourth pixel is connected to the (k+1)-th data line and the (j+1)-th gate line.

3. The display apparatus of claim 2, wherein the first pixel is disposed closer to the k-th data line when compared to the second pixel, and
the third pixel is disposed closer to the k-th data line when compared to the fourth pixel.

4. The display apparatus of claim 1, wherein data voltages applied to the first and second pixels have the same polarity,
data voltages applied to the third and fourth pixels have the same polarity, and
the data voltage applied to the first pixel and the data voltage applied to the third pixel have polarities different from each other.

5. The display apparatus of claim 1, further comprising:
second color pixels configured to display a color different from that displayed by the first color pixels; and
third color pixels configured to display a color different from those displayed by the first and second color pixels,
wherein one of the first color pixels, one of the second color pixels, and one of the third color pixels are sequentially disposed in the second direction.

6. The display apparatus of claim 5, wherein each of the first color pixels displays a red color,
each of the second color pixels displays a green color, and
each of the third color pixels displays a blue color.

7. The display apparatus of claim 5, wherein:
the m gate lines comprise two gate lines disposed between the one of the first color pixels and the one of the second color pixels; and
the m gate lines comprise two other gate lines disposed between the one of the second color pixels and the one of the third color pixels.

8. The display apparatus of claim 1, wherein the first color pixels further comprise a fifth pixel, a sixth pixel, a seventh pixel, and an eighth pixel,
k further satisfies the following condition: 1≦k<(n−1),
the fifth to eighth pixels are disposed between the (k+1)-th data line and a (k+2)-th data line of the n data lines,
the fifth and sixth pixels are disposed between the i-th gate line and the (i+1)-th gate line of the m gate lines,
the seventh and eighth pixels are disposed between the j-th gate line and the (j+1)-th gate line of the m gate lines,
the fifth pixel is connected to the (k+1)-th data line and the (i+1)-th gate line,
the sixth pixel is connected to the (k+1)-th data line and the i-th gate line,
the seventh pixel is connected to the (k+2)-th data line and the j-th gate line, and
the eighth pixel is connected to the (k+2)-th data line and the (j+1)-th gate line.

9. The display apparatus of claim 8, wherein data voltages applied to the first pixel, the second pixel, the seventh pixel, and the eighth pixel have the same polarity,
data voltages applied to the third pixel, the fourth pixel, the fifth pixel, and the sixth pixel have the same polarity, and
the data voltage applied to the first pixel and the data voltage applied to the third pixel have polarities different from each other.

10. The display apparatus of claim 1, wherein the first color pixels further comprise a fifth pixel, a sixth pixel, a seventh pixel, and an eighth pixel,
k further satisfies the following condition: 1≦k<(n−1),
the fifth to eighth pixels are disposed between the (k+1)-th data line and a (k+2)-th data line of the n data lines,
the fifth and sixth pixels are disposed between the i-th gate line and the (i+1)-th gate line of the m gate lines,
the seventh and eighth pixels are disposed between the j-th gate line and the (j+1)-th gate line of the m gate lines,
the fifth pixel is connected to the (k+1)-th data line and the i-th gate line,
the sixth pixel is connected to the (k+1)-th data line and the (i+1)-th gate line,
the seventh pixel is connected to the (k+2)-th data line and the (j+1)-th gate line, and
the eighth pixel is connected to the (k+2)-th data line and the j-th gate line.

11. The display apparatus of claim 1, wherein each of the first to fourth pixels has a long side extending in the first direction and a short side extending in the second direction.

12. A display apparatus comprising:
m gate lines extending in a first direction, where m is a natural number;
n data lines extending in a second direction crossing the first direction, where n is a natural number; and
first color pixels configured to display the same color, the first color pixels comprising a first pixel, a second pixel, a third pixel, and a fourth pixel,
wherein the first to fourth pixels are disposed between a k-th data line of the n data lines and a (k+1)-th data line of the n data lines, where k is a natural number that satisfies the following condition: 1≦k<n,
the first and second pixels are disposed between an i-th gate line of the m gate lines and an (i+1)-th gate line of the m gate lines, where i is a natural number that satisfies the following condition: 1≦i<m,
the third and fourth pixels are disposed between a j-th gate line of the m gate lines and a (j+1)-th gate line of the m gate lines, where j is a natural number that satisfies the following condition: 1≦j≠i<m,
the first pixel is disposed closer to the k-th data line when compared to the second pixel, and the third pixel is disposed closer to the k-th data line when compared to the fourth pixel,
the first pixel is connected to the (k+1)-th data line, the second pixel is connected to the k-th data line, the third pixel is connected to the k-th data line, and the fourth pixel is connected to the (k+1)-th data line,
the first pixel is connected to one of the i-th gate line and the (i+1)-th gate line, and the second pixel is connected to the other one of the i-th gate line and the (i+1)-th gate line, and
the third pixel is connected to one of the j-th gate line and the (j+1)-th gate line, and the fourth pixel is connected to the other one of the j-th gate line and the (j+1)-th gate line.

13. The display apparatus of claim 12, wherein the first pixel is connected to the (k+1)-th data line and the i-th gate line,
the second pixel is connected to the k-th data line and the (i+1)-th gate line,
the third pixel is connected to the k-th data line and the (j+1)-th gate line, and
the fourth pixel is connected to the (k+1)-th data line and the j-th gate line.

14. The display apparatus of claim 12, wherein data voltages applied to the first and fourth pixels have the same polarity,
data voltages applied to the second and third pixels have the same polarity, and
the data voltage applied to the first pixel and the data voltage applied to the third pixel have polarities different from each other.

15. The display apparatus of claim 12, wherein the first color pixels further comprise a fifth pixel, a sixth pixel, a seventh pixel, and an eighth pixel,
k further satisfies the following condition: 1≦k<(n−1),
the fifth to eighth pixels are disposed between the (k+1)-th data line and a (k+2)-th data line of the n data lines,
the fifth and sixth pixels are disposed between the i-th gate line and the (i+1)-th gate line of the m gate lines,
the seventh and eighth pixels are disposed between the j-th gate line and the (j+1)-th gate line of the m gate lines,
the fifth pixel is disposed closer to the (k+1)-th data line when compared to the sixth pixel, and the seventh pixel is disposed closer to the (k+1)-th data line when compared to the eighth pixel,
the fifth pixel is connected to the (k+2)-th data line and the i-th gate line,
the sixth pixel is connected to the (k+1)-th data line and the (i+1)-th gate line,
the seventh pixel is connected to the (k+1)-th data line and the (j+1)-th gate line, and
the eighth pixel is connected to the (k+2)-th data line and the j-th gate line.

16. The display apparatus of claim 15, wherein data voltages applied to the first pixel, the fourth pixel, the sixth pixel, and the seventh pixel have the same polarity,
data voltages applied to the second pixel, the third pixel, the fifth pixel, and the eighth pixel have the same polarity, and
the data voltage applied to the first pixel and the data voltage applied to the second pixel have polarities different from each other.

17. The display apparatus of claim 12, wherein the first color pixels further comprise a fifth pixel, a sixth pixel, a seventh pixel, and an eighth pixel,
k further satisfies the following condition: 1≦k<(n−1),
the fifth to eighth pixels are disposed between the (k+1)-th data line and a (k+2)-th data line of the n data lines,
the fifth and sixth pixels are disposed between the i-th gate line and the (i+1)-th gate line of the m gate lines,
the seventh and eighth pixels are disposed between the j-th gate line and the (j+1)-th gate line of the m gate lines,
the fifth pixel is disposed closer to the (k+1)-th data line when compared to the sixth pixel, and the seventh pixel is disposed closer to the (k+1)-th data line when compared to the eighth pixel,
the fifth pixel is connected to the (k+1)-th data line and the (i+1)-th gate line,
the sixth pixel is connected to the (k+2)-th data line and the i-th gate line,
the seventh pixel is connected to the (k+2)-th data line and the j-th gate line, and
the eighth pixel is connected to the (k+1)-th data line and the (j+1)-th gate line.

18. The display apparatus of claim 17, wherein data voltages applied to the first pixel, the fourth pixel, the fifth pixel, and the eighth pixel have the same polarity,
data voltages applied to the second pixel, the third pixel, the sixth pixel, and the seventh pixel have the same polarity, and
the data voltage applied to the first pixel and the data voltage applied to the second pixel have polarities different from each other.

19. A display apparatus comprising:
m gate lines extending in a first direction, where m is a natural number;
n data lines extending in a second direction crossing the first direction, where n is a natural number; and
first color pixels configured to display the same color, the first color pixels comprising a first pixel, a second pixel, a third pixel, and a fourth pixel,
wherein the first and second pixels are disposed between a k-th data line of the n data lines and a (k+1)-th data line of the n data lines, where k is a natural number that satisfies the following condition: 1≦k<(n−1),
the third and the fourth pixels are disposed between the (k+1)-th data line and a (k+2)-th data line of the n data lines,
the first to fourth pixels are disposed between an i-th gate line of the m gate lines and an (i+1)-th gate line of the m gate lines, where i is a natural number that satisfies the following condition: 1≦i<m,
the first pixel is disposed closer to the k-th data line when compared to the second pixel, and the third pixel is disposed closer to the (k+1)-th data line when compared to the fourth pixel,
the first pixel is connected to the (k+1)-th data line, the second pixel is connected to the k-th data line, the third pixel is connected to the (k+1)-th data line, and the fourth pixel is connected to the (k+2)-th data line,
the first pixel is connected to one of the i-th gate line and the (i+1)-th gate line, and the second pixel is connected to the other one of the i-th gate line and the (i+1)-th gate line, and
the third pixel is connected to one of the i-th gate line and the (i+1)-th gate line, and the fourth pixel is connected to the other one of the i-th gate line and the (i+1)-th gate line.

20. The display apparatus of claim 19, wherein each of the first and fourth pixels is connected to the i-th gate line, and
each of the second and third pixels is connected to the (i+1)-th gate line.
